(19) United States
(12) Patent Application Publication
(10) Pub. No.: US 2011/0080819 A1
(43) Pub. Date: Apr. 7, 2011

(54) SYSTEMS AND METHODS FOR RELIABILITY TESTING OF OPTICAL MEDIA USING SIMULTANEOUS HEAT, HUMIDITY, AND LIGHT

(76) Inventors: Michael L. BAILEY, Gig Harbor, WA (US); David A. BELL, Farmington, UT (US); Douglas P. HANSEN, Spanish Fork, UT (US); Barry M. LUNT, Provo, UT (US)

(21) Appl. No.: 12/871,908

(22) Filed: Aug. 31, 2010

Related U.S. Application Data
(60) Provisional application No. 61/238,622, filed on Aug. 31, 2009.

(51) Int. Cl. G11B 27/36

(52) U.S. Cl. 369/53.2; G9B/27.052

(57) ABSTRACT

Methods and systems for the rapid evaluation of optical media reliability are disclosed. Simultaneous exposure of optical media to heat, humidity, and light has been found to be an effective test to differentiate more stable media from less stable media in a reasonable amount of time.

### CROSS-REFERENCE TO RELATED APPLICATIONS

Priority is claimed from U.S. Provisional Patent Application 61/238,622, filed 31 Aug. 2009, which is hereby incorporated by reference.

### BACKGROUND

The current industry standard for testing the longevity of optical discs is the standard developed by Ecma International, a non-profit organization based in Geneva, Switzerland. In developing the standard, ECMA-379 1st Edition was fast-tracked to the International Standards Organization (ISO/IEC JTC1) in August 2007, where it was slightly modified, published, and approved as the standard ISO/IEC IS 10995. This standard was published by ISO/IEC in April 2008. The Standard ECMA-379 2nd Edition, entitled, “Test Method for Estimation of the Archival Lifetime of Optical Media”, published in December of 2008, is technically identical with the published ISO/IEC Standard IS 10995 1st Edition. This standard requires testing of specific samples of optical discs after exposure to stressed conditions of heightened temperature and heightened humidity for extended periods of time. The periods of increased temperature and humidity last at least one thousand hours (about 42 days), and in some cases these stress tests last up to two thousand five hundred hours (about 104 days, or about 15 weeks). After the stress conditions, the discs are checked in various ways to detect degradation.

There are also standard testing methods for measuring the chemical degradation or coatings, such as paints. For example, Xiaohong Gu, et al. “Linking Accelerate Laboratory Test with Outdoor Performance Results for a Model Epoxy Coating System”, discloses the use of the NIST SPHERE (Simulated Photodegradation via High Energy Radiant Exposure) to perform accelerated testing of epoxy coatings. Further disclosures of SPHERE are found in Chin, J. W., Byrd, W. E., Embree, E., Martin, J. W., and Tate, J. D., “Ultraviolet Chambers Based on Integrating Spheres for Use in Artificial Weathering,” J. Coat. Technol., 74, No. 929, p. 39 (2002), and Chin, J. W., Byrd, W. E., Embree, E., and Martin, J. W., “Integrating Sphere Sources for UV Exposure,” Service Life Prediction: Methodology and Metrologies, Martin, J. W. and Bauer, D. (Eds.), Oxford Press, NY, p. 144, 2001. As disclosed in these references, coatings are evaluated by controlled exposure to light, high temperature and humidity, and evaluating the chemical changes or degradation of the coating by measuring degradation products. Being measured here are non-reversible chemical and physical changes to the bulk properties of the coating. These test differ from tests for optical media in that in optical media tests the property being tested is data integrity or data retention, rather than physical or chemical degradation. The changes that effect data integrity are often not the same as the chemical and physical measures of these standard coating tests. For example, a slight creep, or a small irreversible expansion or contraction can be an inconsequential and not measurable physical change in a coating evaluation. However, on an optical storage media, even a creep of 10 nm can result in an irreversible data loss. Thus, if the environment conditions to which an optical disk is exposed result in even small irreversible changes, the media will fail to retain data. Such changes affecting data retention are often not contemplated or measurable in the coating tests, and the changes that are measured in these tests do not clearly relate to any changes in data retention.

Several patent publications and patents discussed below refer to tests and standards for describing the quality of their optical discs. These patent publications and patents refer to light exposure tests, some of which reference a separate ISO standard.

For example, U.S. Patent Publication No. 2009/0135706, published May 28, 2009 to Noguchi et al. discloses stressing optical recording media by exposure to continuous irradiation of Xenon light for fifty hours at an illumination of 40 k lux. Separately, Noguchi describes a storage test that involves leaving the media at a temperature of 50° C. and a relative humidity of 80% for 800 hours (about 33 days).

U.S. Patent Publication No. 2008/0254252, published Oct. 16, 2008 to Watanabe discloses light resistance testing of certain dye based data materials by exposing the media containing the materials to Xenon light for 55 hours in a “merry-go-round” shaped light resistance tester. A separate high temperature and high humidity stress test was applied to the media for either 24 hours or 168 hours. Watanabe's 24-hour test was performed at 60° C. and 90% relative humidity, but Watanabe did not indicate the temperature or humidity for the 168-hour test.

U.S. Pat. No. 6,124,075, issued Sep. 26, 2000 to Ishihara et al. discloses holding laser ablative recording media samples under a white fluorescent lamp having an intensity of 800 lux for periods of four hours or eight hours. An absorption spectrum of the samples was measured before and after exposure to the light. Ishihara discloses a separate test in which the samples are held in an environment of 60° C. and 70% relative humidity for three days, after which a similar evaluation of the change in the absorption was performed.

U.S. Pat. No. 5,939,163, issued Aug. 17, 1999 to Ueno et al. discloses exposing optical information recording media to Xenon light irradiation at 40 k lux for 720 hours (30 days). A separate stress test included storage at 85° C. and 85% humidity for 720 hours (30 days). The effects were shown in tabular form with the results for each of these tests in separate columns.

U.S. Patent Publication No. 2006/0280066, published Dec. 14, 2006 to Yusu et al. discloses continuously irradiating information storage discs with light prior to an acceleration test involving high temperature and high humidity. The subsequent acceleration test consists of maintaining the discs at 85° C. and 85% relative humidity for 400 hours (about 17 days).

U.S. Patent Publication 2007/0184386, published Aug. 9, 2007 to Miyazawa et al. tests for light resistance by irradiating an optical recording medium with a Xenon lamp at 45° C. and 250 W/m² for eight hours. The absorbance was measured before and after exposure of the media to the light.

U.S. Pat. No. 6,368,692, issued Apr. 9, 2002 to Yamazaki et al. discloses evaluating an optical storage media by obtaining initial reproducing signals, and obtaining reproducing signals after irradiating with a metal halide lamp of 1500 W for fifty hours at an energy density of 30 mW/cm² at the surface of the media.

U.S. Pat. No. 7,507,524, issued Mar. 24, 2009 to Satake et al. discloses a specific ISO standard for accelerated light tests. This standard is designated as ISO-105-B02 in these references.

As may be appreciated, there are a large number of tests and many variations in the tests. Also, it is noted that these tests change as the standards change over the years. These changes imply that different and improved standards are needed. However, the standards and tests appear to have generally changed in degree rather than in substance over the years such that the current industry standards and tests are suspected to still be inadequate. Most of the disclosed tests involve long exposure times, and are quite burdensome to perform and occupy test equipment for long periods of time. The long test times makes these assays impractical for product development/improvement. Additionally, consumers are unable to use these tests to influence purchase decisions, again as the tests take too long to complete. Accordingly, there exists a need for an improved universal accelerated test that evaluates degradation and predicts the quality of optical information media in key environmental conditions.

### SUMMARY

Methods and systems for rapidly evaluating the quality of optical media are disclosed. Simultaneous exposure of optical media to elevated heat, humidity, and light has been found to provide a rapid and effective evaluation of the reliability of the media. Determining quality or error values of the media before and after exposure allows comparison of various media, and allows prediction of media reliability and dependability.

Simultaneous exposure to elevated heat, humidity, and light provides a synergistic combination in the rapid and effective evaluation of media. The application of any one of the conditions enhances the rapidity and effectiveness of the other two. Thus, without the simultaneous exposure to all three conditions, heat, humidity, and light, a rapid and effective evaluation would be more difficult or impossible.

Without being bound to any theory, it is believed that with simultaneous exposure, an optimum combination of reaction conditions, reactants, and activators is achieved. Light, humidity, and heat are known activators/reactants of many chemical reactions, and there are numerous examples of chemical reactions in which at least two of these activators must be present for a reaction to occur in a reasonable period of time. For example, hydrolysis reactions clearly require water. In addition, it is a well-known rule of thumb that chemical reactions are accelerated by a factor of about two for every 10° C. increase in temperature of a reaction. Therefore, going from 25° C. (room temperature) to 85° C. should increase all chemical reactions by a factor of 2⁶=64, which is a substantial increase. Light, especially blue or UV light has a significant amount of energy—enough to break some chemical bonds. At a minimum, it can be said that under exposure of UV light, electrons are promoted to higher energy states, often putting a molecule in a position of being able to react with a nearby reactant, which could be oxygen or water. Diffusion constants, which govern the mobility of molecules, increase exponentially (not linearly) with temperature. Therefore, higher temperatures will increase the mobility of water and oxygen in an optical disc, providing a steady stream of these reactants for UV-activated dyes and other materials in the disc. Thus, it appears that the presence of elevated humidity, heat, and light together will result in many accelerated chemical reactions, and also open up other new possible chemical reactions, which are not achievable by elevating only one or two of humidity, heat, and light. These accelerated and new chemical reactions can lead to greatly accelerated damage or destruction of the materials, including and especially the dyes, of an optical disc, which makes a rapid and effective evaluation possible.

### DESCRIPTION OF THE FIGURES

FIG. 1 shows a system for accelerated testing and evaluation of optical media. The system 12 can contain one or more optical media 15, an environmental chamber 20, and an analyzer device 40. The system can also contain a graphical display device 45. The environmental chamber 20 can contain a light source 25, a holder 30, and one or more spindles or holding mechanisms 35.

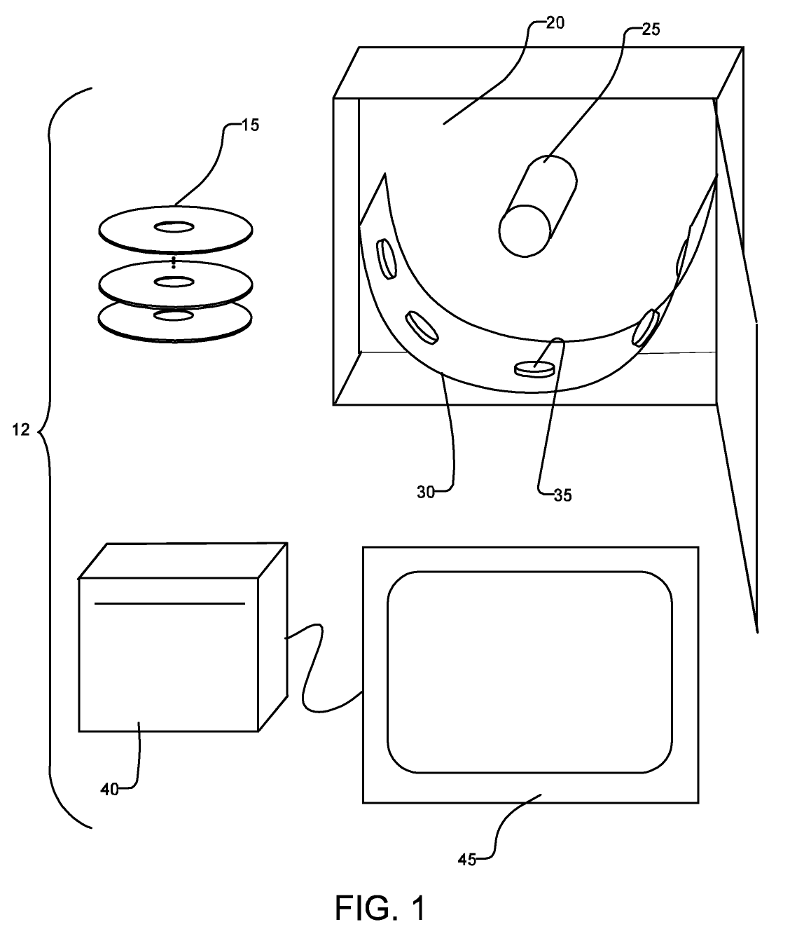

FIG. 2 shows PIE8-maximum values of various discs before and after 48-hour exposure to heat, humidity, and light. The y-axis is PIE8-maximum, and the x-axis is the disc samples. The y-axis does not show values higher than 3500. The shaded bars represent initial values prior to exposure, the white bars represent 24-hour post-exposure values, and the black bars represent 48-hour post-exposure values.

FIG. 3 shows PIE8-average values of various discs before and after 48-hour exposure to heat, humidity, and light. The y-axis is PIE8-average, and the x-axis is the disc samples. The y-axis does not show values higher than 3500. The shaded bars represent initial values prior to exposure, the white bars represent 24-hour post-exposure values, and the black bars represent 48-hour post-exposure values.

FIG. 4 shows PIE8-events values of various discs before and after 48-hour exposure to heat, humidity, and light. The y-axis is PIE8-events, and the x-axis is the disc samples. The y-axis does not show values higher than 4000. The shaded bars represent initial values prior to exposure, the white bars represent 24-hour post-exposure values, and the black bars represent 48-hour post-exposure values.

FIG. 5 shows PIE-maximum values of various discs before and after 48-hour exposure to heat, humidity, and light. The y-axis is PIE-maximum, and the x-axis is the disc samples. The y-axis does not show values higher than 300. The shaded bars represent initial values prior to exposure, the white bars represent 24-hour post-exposure values, and the black bars represent 48-hour post-exposure values.

FIG. 6 shows PIE-average values of various discs before and after 48-hour exposure to heat, humidity, and light. The y-axis is PIE-average, and the x-axis is the disc samples. The y-axis does not show values higher than 200. The shaded bars represent initial values prior to exposure, the white bars represent 24-hour post-exposure values, and the black bars represent 48-hour post-exposure values.

FIG. 7 shows a two-dimensional graphic display of the PIE8-maxi mum values for combinations of five manufacturers of optical media against three manufacturers of DVD disc drives. The y-axis does not show values higher than 200.

### DETAILED DESCRIPTION

### Methods of Evaluating Quality of Optical Media

One embodiment is directed towards methods of evaluating the reliability of optical media. End users greatly prefer their optical media to be durable, robust, and reliable over time. Ideally, optical media will remain readable in the future after storage under a variety of conditions. While users typically store optical media under “reasonable” conditions, media are randomly exposed to “The methods comprise exposing optical media simultaneously to elevated heat, elevated humidity, and light for a period of time.

In one embodiment, the method can comprise providing optical media; evaluating the initial quality of the optical media; simultaneously exposing the optical media for a period of time to elevated heat, elevated humidity, and light; and evaluating the post-exposure quality of the optical media. Generally speaking, the more intense the heat, humidity, and light, the shorter the period of time can be in order to obtain sufficient test results.

The optical media can generally be any type of optical media used to store digital data. Commonly used optical media include discs using CD, DVD, and Blu-ray technologies. The optical media evaluated can be a single article of optical media, or multiple articles of optical media. In some situations, it may be desirable to evaluate multiple articles in order to obtain statistical metrics for the evaluation. The multiple articles can all be the same type of optical media, or they can be different types. For example, discs from multiple lots and/or multiple manufacturers can be evaluated in order to compare variations between lots, or differences between manufacturers.

The initial quality and post-exposure quality can generally be determined using any metric or combinations of multiple metrics. Examples of such metrics are evaluating the error rate of the optical media. Examples of error rates include block error rate (BLER), parity inner error (PIE), parity inner error 8 max (PIE8 max; maximum of the sum of Parity Inner Errors in 8 consecutive ECC blocks), parity inner error 8 average (PIE8 average; average of the sum of Parity Inner Errors in 8 consecutive ECC blocks), parity inner error 8 events (PIE8 events, the number of times that a previously set PIE8 threshold is met or exceeded during analysis of the optical media), PIF (parity inner failures), PIF bytes, and POF (parity outer failures). Another measure of quality is jitter. For all of these measurements, lower values are more desired. Any one or combinations of these measurements may be used.

The quality of optical media can be easily measured using various instruments, such as a Pulstec ODU1000 instrument (Pulstec Industrial Co., Ltd.; Hamamatsu-City; Japan) or a ShuttlePlex analyzer (Optical Disc Technologies; Irvine, Calif.). The initial quality can be represented by an initial error rate, and the post-exposure quality can be represented by a post-exposure error rate. For reference, the ECMA-379 standard states a PIE8-maximum value exceeding 280 as a failure. Higher or lower values may be selected, such as 150, 175, 200, 225, 250, 275, 300, 325, 350, or ranges between any two of these values.

The period of time of exposure to heat, humidity, and light can generally be any period of time sufficient to evaluate the reliability of the optical media. For example, the period of time can be about 24 hours, about 48 hours, about 72 hours, about 96 hours, about 120 hours, and so on. The period of time can be a single period of time, where the quality of the optical media is measured only twice, once prior to exposure to give an initial quality, and once after exposure to give a final quality. Alternatively, the period of time can be made of multiple periods of time. For example, the quality of the optical media can be measured initially, after 24 hours, after 48 hours, and after 72 hours. Shorter or longer time intervals can be used. As an extreme example, the quality of the optical media can be measured continuously over the period of time.

The elevated heat can generally be any temperature higher than ambient room temperature. Ambient room temperature is typically about 22° C. (about 72° F.). Higher temperatures accelerate degradation of the optical media, and allow for more rapid analysis of the optical media's reliability. Temperature ranges can be about 60° C. to about 120° C., or about 70° C. to about 100° C. Specific examples of elevated heat include about 60° C., about 70° C., about 80° C., about 90° C., about 100° C., about 110° C., about 120° C., and ranges between any two of these values. A presently preferred temperature for polycarbonate optical media is about 80° C. Optical media having different substrate compositions may be able to tolerate higher temperatures.

The elevated humidity can generally be any humidity. Ambient humidity varies dramatically by geography and season. For example, the July humidity in Houston, Tex. can be 95%, the September humidity in Portland, Oreg. can be 50%, and the May humidity in Phoenix, Ariz. can be 10%. Higher humidities accelerate degradation of the optical media, and allow for more rapid analysis of the optical media's reliability. A humidity range can be about 75% to about 100%, or about 80% to about 90%. Specific examples of elevated humidity include about 75%, about 80%, about 85%, about 90%, about 95%, about 100%, and ranges between any two of these values. A presently preferred humidity for polycarbonate optical media is about 85%.

The exposure to light can generally be at any intensity of light. The light preferably comprises UVA light, UVB light, or both UVA and UVB light. The exposure to light commonly will be performed using full-spectrum light, designed to simulate sunlight at 5200 K. The intensity of light is commonly measured in mWatts/cm². Ranges of light intensity can include about 0.1 mWatts/cm² to about 1,000 mWatts/cm², and about 1 mWatts/cm² to about 100 mWatts/cm², and about 40 mWatts/cm² to about 60 mWatts/cm². Specific examples of light intensity include about 0.1 mWatts/cm², about 0.5 mWatts/cm², about 1 mWatts/cm², about 5 mWatts/cm², about 10 mWatts/cm², about 20 mWatts/cm², about 30 mWatts/cm², about 40 mWatts/cm², about 50 mWatts/cm², about 60 mWatts/cm², about 70 mWatts/cm², about 80 mWatts/cm², about 90 mWatts/cm², about 100 mWatts/cm², about 200 mWatts/cm², about 300 mWatts/cm², about 400 mWatts/cm², about 500 mWatts/cm², about 600 mWatts/cm², about 700 mWatts/cm², about 800 mWatts/cm², about 900 mWatts/cm², about 1,000 mWatts/cm², and ranges between any two of these values. A variety of light sources can be used to provide exposure. Examples of light sources include lamps, metal halide lamps, and LEDs.

The method can further comprise comparing the initial quality and post-exposure quality of the optical media. In an ideal case, the initial quality and post-exposure quality are substantially identical, suggesting high reliability and a desirable optical media for long-term data storage. Conversely, if the post-exposure quality is substantially lower than the initial quality, or if the post-exposure error rate is substantially higher than the initial error rate, this suggests a low reliability and an undesirable optical media for long-term data storage. The initial quality and post-exposure quality (or the initial error rate and the post-exposure error rate) of the optical media can be plotted and graphically displayed. Comparisons may be made in terms of absolute changes (the delta between the initial quality and the post-exposure quality), or percent change.

Comparative evaluations can be performed between multiple different optical media. The optical media can be separated into (a) more desired optical media that have smaller differences between the initial quality and post-exposure quality, and (b) less desired optical media that have larger differences between the initial quality and post-exposure quality. Objective quantitative values may be used to separate more desired optical media from less desired optical media. For example, a PIE8-maxi mum value exceeding 280 is unacceptable under ECMA-379, while a PIE8-maxi mum value lower than 280 is more desired. Other metrics or numbers may be used to compare more desired optical media and less desired optical media.

Methods of Evaluating Optical Media Quality and Consistency

An additional method for evaluating optical media quality involves screening optical media and media drives to identify more favorable and less favorable combinations. Contrary to common belief, all optical media are not created equally, and all media drives are not created equally. The instant inventors have surprisingly found that particular combinations of optical media and media drives give unexpectedly good or bad quality results when used together.

One embodiment relates to methods for identifying favorable combinations of optical media and media drives. The methods can comprise: providing M number of optical media; providing N number of media drives; writing data to the optical media using each combination of optical media and media drives; measuring the post-writing quality values of each of the optical media, for a total of M times N measured quality values; and comparing the measured quality values; wherein: M is an integer of one or more; N is an integer of one or more; and at least one of M and N is two or more.

The measuring of post-writing quality values can be any of the measurements described above, including comprising measuring block error rate (BLER), parity inner error (PIE), parity inner error 8 max (PIE8 max; maximum of the sum of Parity Inner Errors in 8 consecutive ECC blocks), parity inner error 8 average (PIE8 average; average of the sum of Parity Inner Errors in 8 consecutive ECC blocks), parity inner error 8 events (PIE8 events), PIF (parity inner failures), PIF bytes, POF (parity outer failures), jitter, or combinations thereof.

The values of M and N can be the same or different. In certain embodiments, M can be two or more and N can be two or more. Specific examples of M include 1, 2, 3, 4, 5, 6, 7, 8, 9, 10, 11, 12, 13, 14, 15, 16, 17, 18, 19, 20, and so on. Specific examples of N include 1, 2, 3, 4, 5, 6, 7, 8, 9, 10, 11, 12, 13, 14, 15, 16, 17, 18, 19, 20, and so on.

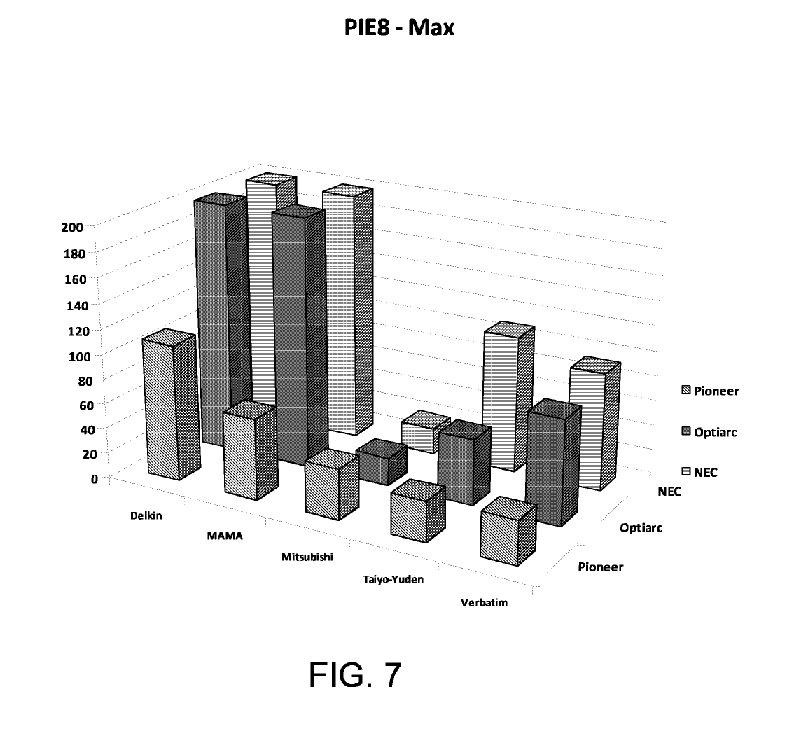

The method can further comprise graphically displaying the measured quality values. An example of such a graphic display is shown in FIG. 7.

The method can further comprise selecting the combination of optical media and media drives that produced the best post-writing quality value. If M is one, then this selection is selecting the media drive that gives the best quality value with the designated optical media. If N is one, this selection is selecting the optical media that gives the best quality value with the designated media drive.

Systems to Evaluate Optical Media

An additional embodiment directed towards systems that may be used for performing the above-described methods for evaluating optical media.

The system can comprise at least one article of optical media, an analyzer device that evaluates the initial write or written quality of the optical media and the post-exposure quality of the optical media, and an environmental chamber that exposes the optical media to elevated heat, elevated humidity, and light. The system can further comprise at least one drive device that writes data to the optical media prior to evaluation of the initial quality.

The environmental chamber can be coupled to a controller unit programmable to provide constant heat or variable heat, constant humidity or variable humidity, and constant light or variable light, and various combinations thereof. The environmental chamber can further comprise at least one meter that measures temperature, humidity, light intensity, or combinations thereof.

The system can further comprise a graphical display device to compare the initial quality of the optical media and the post-exposure quality of the optical media. Presently, the graphical display device is a computer that can display tables, charts, or graphs.

An additional embodiments directed towards an environmental chamber. The chamber comprises a heat source, a humidity source, and a light source. The chamber is coupled to a controller unit that controls heat, humidity, and light in the chamber. The chamber is configured to simultaneously expose multiple optical media to elevated heat, elevated humidity, and light. Ideally, the chamber exposes the multiple optical media to substantially the same heat, humidity, and light over the time period of the exposure.

The chamber can further comprise a holder that holds the multiple optical media. The media can be positioned at fixed locations, or can be movably positioned. The holder can have one or more spindles, clips, or other holding mechanisms configured to hold the optical media. In a simple configuration, the holder positions the multiple optical media at about equal distances from the light source. In more complex configurations, the holder can comprise a carousel, conveyor, or other movable mechanism that moves the optical media within the chamber.

### EXAMPLES

### Example 1

### Optical Media Sources

Six discs from each of the following five sources were obtained: Millenniata (M-Arc™ disc; Millenniata, Inc.; Provo, Utah), Mitsubishi (Falcon Media Pro Century Gold Archival; Lot MCC 02RG20; Mitsubishi, Japan), Verbatim (Archival Grade DVD-R 8X; Lot 02RG20; Verbatim; Charlotte, N.C.), Delkin (Archival Gold DVD-R 100 year disc; Lot MBI 01 RG40; Delkin Devices, Inc.; Poway, Calif.), MAM-A (DVD-R 4.7 Archive 8X; Lot MBI 01 RG40; MAM-A, Inc.; Colorado Springs, Colo.), and Taiyo Yuden (DVD-R 4.7 GB; lot TYG02; Schaumberg, Ill.).

### Example 2

### Measurement of Disc Quality/Error Rate

The discs were measured for their PIE8-max, PIE8-average, PIE8-events, PI-max, and PI-average at various time periods using a ShuttlePlex DVD analyzer (Optical Disc Technologies; Irvine, Calif.). Values were graphically displayed using common spreadsheet and graphing software on an Apple Macintosh MacBook Pro computer.

### Example 3

### Environmental Chambers

Model FRC-27F temperature and humidity chambers (Blue M; LOCATION) were used for testing. The chambers were equipped with a light source. A holder was used that place optical discs on spindles held 27-30 cm from the light source.

The light source was a pair of UHI-150DD/UVP Euroflood™ UHI series 150 Watt, 95 Volt compact metal halide lamps (5200 K color temp; 11000 lm luminous flux; Ushio America; Cypress, Calif.). The light intensity at the discs was measured to be between 43 mW/cm² and 53 mW/cm².

Conditions within the chamber were controlled using a JC Systems 600-RTD programmable temperature and humidity controller unit (TMC Services, Inc.; Elk River, Minn.).

### Example 4

### Exposure Conditions

The following test profile was used to evaluate reliability of various optical discs.

TABLE 1
Ramping test sequence

| Step | Action | Time |
|---|---|---|
| 1 | Turn on light source | |
| 2 | Ramp from ambient humidity to 15% humidity | 0.25 hours |
| 3 | Ramp from room temperature to 80° C. | 0.5 hours |
| 4 | Ramp from 15% humidity to 85% humidity | 0.5 hours |
| 5 | Soak at 85% humidity and 80° C. temperature | 24, 48, or 72 |
| | | hours as desired |
| 6 | Ramp humidity from 85% to 15% | 0.5 hours |
| 7 | Soak humidity and temp | 0.25 hours |
| 8 | Ramp chamber to ambient humidity and | 0.5 hours |
| | temperature | |
| 9 | Turn off light source; remove optical media from | |
| | chamber for analysis. | |

The following tables show the initial and post-exposure error rate measurements for the various discs. Measurements were taken initially before exposure, after 24 hours of exposure, and after 48 hours of exposure. In the tables, AR refers to Millenniata discs, MI refers to Mitsubishi discs, VE refers to Verbatim discs, DE refers to Delkin discs, and MA refers to MAM-A discs.

TABLE 2
PIE8-max values

| Disc | Initial | 24 Hour | 48 Hour | Delta | Delta % |
|---|---|---|---|---|---|
| AR 51002 | 101 | 80 | 89 | 12 | 0 |
| AR 65001 | 88 | 68 | 86 | 2 | 0 |
| AR A2002 | 89 | 148 | 86 | 3 | 0 |
| AR B6002 | 89 | 70 | 105 | 15 | 0 |
| AR E3001 | 18 | 304 | 87 | 69 | 4 |
| AR I4003 | 15 | 83 | 76 | 62 | 4 |
| AR1 | 131 | 92 | 93 | 38 | 0 |
| AR2 | 121 | 86 | 92 | 29 | 0 |
| AR3 | 149 | 87 | 87 | 63 | 0 |
| AR4 | 153 | 85 | 99 | 54 | 0 |
| AR5 | 129 | 109 | 111 | 18 | 0 |
| AR6 | 143 | 91 | 92 | 51 | 0 |
| MI11 | 18 | 42 | 213 | 196 | 11 |
| MI12 | 14 | 67 | 1334 | 1320 | 97 |
| MI13 | 13 | 73 | 1073 | 1061 | 85 |
| MI14 | 14 | 119 | 3445 | 3431 | 241 |
| MI15 | 14 | 35 | 1074 | 1060 | 75 |
| MI16 | 41 | 177 | 515 | 474 | 11 |
| VE11 | 11 | 51 | 5000 | 4989 | 456 |
| VE12 | 8 | 13 | 503 | 495 | 61 |
| VE13 | 5 | 13 | 542 | 536 | 98 |
| VE14 | 6 | 40 | 5000 | 4994 | 881 |
| VE15 | 7 | 13 | 2192 | 2185 | 306 |
| VE16 | 10 | 17 | 336 | 326 | 32 |
| DE1 | 128 | 720 | 1228 | 1099 | 9 |
| DE2 | 80 | 564 | 1235 | 1156 | 14 |
| DE3 | 61 | 407 | 914 | 853 | 14 |
| DE4 | 49 | 469 | 5000 | 4951 | 101 |
| DE5 | 65 | 506 | 1528 | 1463 | 23 |
| DE6 | 58 | 431 | 1455 | 1397 | 24 |
| MA1 | 194 | 405 | 571 | 378 | 2 |
| MA2 | 158 | 631 | 1085 | 927 | 6 |
| MA3 | 113 | 282 | 472 | 359 | 3 |
| MA4 | 106 | 429 | 839 | 733 | 7 |
| MA5 | 88 | 218 | 356 | 267 | 3 |
| MA6 | 177 | 867 | 1672 | 1495 | 8 |

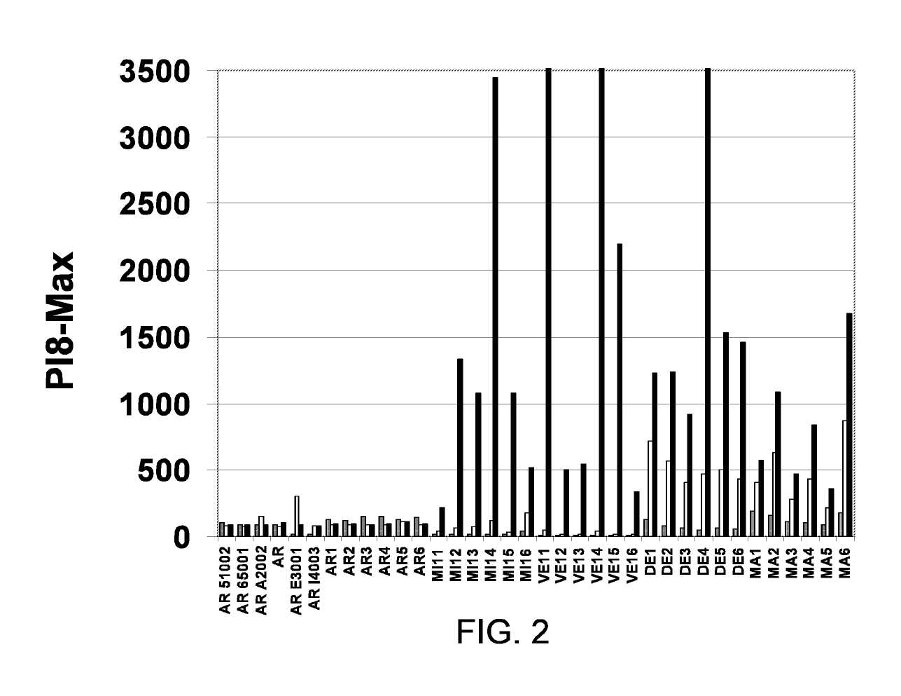

The PIE8-max results of Table 2 are graphically displayed in FIG. 2. The Millenniata discs' PIE8-max values were largely unchanged by exposure to heat, humidity, and light. The Mitsubishi and Verbatim discs had lower initial PIE8-max values, but significantly higher PIE8-max values after 48-hour exposure. The Delkin and MAM-A discs had similar initial PIE8-max values as the Millenniata discs, but significantly higher PIE8-max values after both 24-hour and 48-hour exposure.

TABLE 3
PIE8-average values

| Disc | Initial | 24 Hour | 48 Hour | Delta | Delta % |
|---|---|---|---|---|---|
| AR 51002 | 68 | 49 | 50 | 19 | 0 |
| AR 65001 | 53 | 38 | 48 | 6 | 0 |
| AR A2002 | 57 | 42 | 48 | 9 | 0 |
| AR B6002 | 59 | 42 | 56 | 3 | 0 |
| AR E3001 | 5 | 84 | 47 | 42 | 8 |
| AR I4003 | 4 | 47 | 43 | 39 | 9 |
| AR1 | 89 | 60 | 58 | 31 | 0 |
| AR2 | 86 | 53 | 60 | 26 | 0 |
| AR3 | 103 | 55 | 54 | 50 | 0 |
| AR4 | 107 | 52 | 63 | 44 | 0 |
| AR5 | 88 | 72 | 74 | 14 | 0 |
| AR6 | 96 | 53 | 53 | 43 | 0 |
| MI11 | 5 | 19 | 153 | 148 | 29 |
| MI12 | 4 | 37 | 1153 | 1149 | 286 |
| MI13 | 3 | 31 | 898 | 895 | 259 |
| MI14 | 3 | 88 | 3408 | 3405 | 1096 |
| MI15 | 4 | 17 | 918 | 915 | 256 |
| MI16 | 22 | 129 | 402 | 380 | 18 |
| VE11 | 2 | 31 | 5000 | 4998 | 2973 |
| VE12 | 1 | 5 | 394 | 393 | 347 |
| VE13 | 1 | 5 | 378 | 377 | 596 |
| VE14 | 1 | 23 | 5000 | 4999 | 6888 |
| VE15 | 1 | 4 | 2043 | 2042 | 2671 |
| VE16 | 1 | 6 | 266 | 264 | 199 |
| DE1 | 62 | 496 | 964 | 902 | 15 |
| DE2 | 43 | 429 | 1023 | 981 | 23 |
| DE3 | 30 | 271 | 713 | 683 | 23 |
| DE4 | 25 | 356 | 5000 | 4975 | 203 |
| DE5 | 35 | 399 | 1319 | 1283 | 36 |
| DE6 | 31 | 328 | 1247 | 1215 | 39 |
| MA1 | 120 | 273 | 401 | 280 | 2 |
| MA2 | 102 | 476 | 868 | 766 | 8 |
| MA3 | 65 | 176 | 307 | 242 | 4 |
| MA4 | 63 | 294 | 646 | 583 | 9 |
| MA5 | 54 | 153 | 250 | 196 | 4 |
| MA6 | 115 | 671 | 1468 | 1354 | 12 |

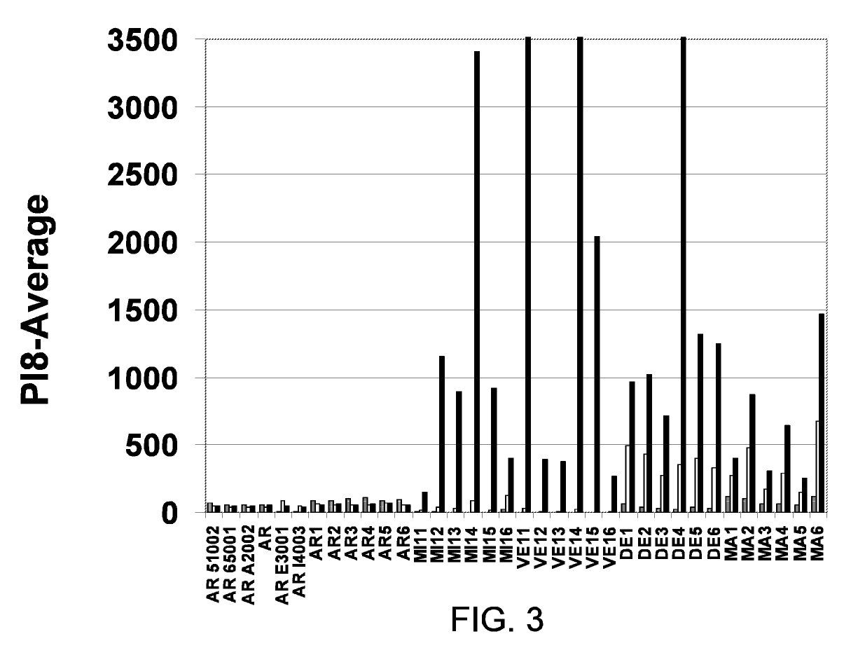

The PIE8-average results of Table 3 are graphically displayed in FIG. 3. The Millenniata discs' PIE8-average values were largely unchanged by exposure to heat, humidity, and light, and in some cases actually decreased. The Mitsubishi and Verbatim discs had lower initial PIE8-average values, but significantly higher PIE8-average values after 48-hour exposure. The Delkin and MAM-A discs had similar initial PIE8-average values as the Millenniata discs, but significantly higher PIE8-average values after both 24-hour and 48-hour exposure.

TABLE 4
PIE8-events

| Disc | Initial | 24 Hour | 48 Hour | Delta | Delta % |
|---|---|---|---|---|---|
| AR 51002 | 108 | 25 | 30 | | |
| AR 65001 | 0 | 0 | 0 | | |
| AR A2002 | 0 | 15 | 0 | | |
| AR B6002 | 0 | 0 | 151 | | |
| AR E3001 | 0 | 137 | 1 | | |
| AR I4003 | 0 | 9 | 0 | | |
| AR1 | 228 | 108 | 53 | | |
| AR2 | 219 | 8 | 49 | | |
| AR3 | 284 | 7 | 1 | | |
| AR4 | 275 | 33 | 120 | | |
| AR5 | 233 | 137 | 162 | | |
| AR6 | 237 | 6 | 11 | | |
| MI11 | 0 | 0 | 823 | | |
| MI12 | 0 | 8 | 1744 | | |
| MI13 | 0 | 7 | 1755 | | |
| MI14 | 0 | 233 | 4157 | | |
| MI15 | 0 | 0 | 1647 | | |
| MI16 | 0 | 258 | 2061 | | |
| VE11 | 0 | 0 | 5000 | | |
| VE12 | 0 | 0 | 1709 | | |
| VE13 | 0 | 0 | 862 | | |
| VE14 | 0 | 0 | 5000 | | |
| VE15 | 0 | 0 | 3313 | | |
| VE16 | 0 | 0 | 985 | | |
| DE1 | 167 | 466 | 5000 | | |
| DE2 | 66 | 466 | 5000 | | |
| DE3 | 0 | 466 | 5000 | | |
| DE4 | 0 | 466 | 5000 | | |
| DE5 | 0 | 470 | 5000 | | |
| DE6 | 0 | 466 | 5000 | | |
| MA1 | 250 | 469 | 698 | | |
| MA2 | 233 | 466 | 657 | | |
| MA3 | 196 | 420 | 697 | | |
| MA4 | 207 | 466 | 466 | | |
| MA5 | 75 | 460 | 648 | | |
| MA6 | 255 | 466 | 5000 | | |

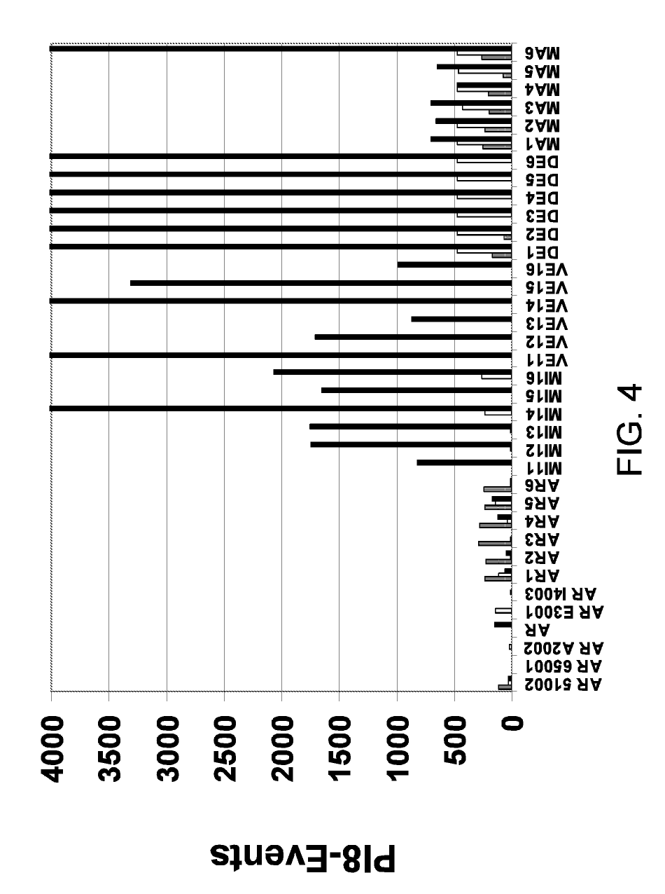

The PIE8-events results of Table 4 are graphically displayed in FIG. 4. Unreadable discs were given an arbitrary PIE8-events value of 5,000. The Millenniata discs' PIE8-events values were either largely unchanged or decreased by exposure to heat, humidity, and light. In one case, a Millenniata disc's PIE8-events value went from zero to 151. The Mitsubishi and Verbatim discs all had initial PIE8-events values of zero, but significantly higher PIE8-events values after 48-hour exposure. The Delkin and MAM-A discs had similar initial PIE8-events values as the Millenniata discs, but significantly higher PIE8-events values after both 24-hour and 48-hour exposure.

TABLE 5
PIE-max values

| Disc | Initial | 24 Hour | 48 Hour | Delta | Delta % |
|---|---|---|---|---|---|
| AR 51002 | 24 | 20 | 21 | 2 | 0 |
| AR 65001 | 20 | 17 | 21 | 1 | 0 |
| AR A2002 | 22 | 34 | 22 | 0 | 0 |
| AR B6002 | 21 | 19 | 27 | 6 | 0 |
| AR E3001 | 6 | 57 | 22 | 16 | 3 |
| AR I4003 | 6 | 24 | 21 | 15 | 3 |
| AR1 | 28 | 23 | 22 | 6 | 0 |
| AR2 | 26 | 19 | 22 | 4 | 0 |
| AR3 | 30 | 20 | 20 | 10 | 0 |
| AR4 | 32 | 22 | 28 | 4 | 0 |
| AR5 | 28 | 24 | 25 | 2 | 0 |
| AR6 | 28 | 20 | 20 | 8 | 0 |
| MI11 | 6 | 13 | 61 | 55 | 10 |
| MI12 | 5 | 16 | 275 | 270 | 51 |
| MI13 | 4 | 22 | 258 | 254 | 57 |
| MI14 | 5 | 53 | 3362 | 3357 | 667 |
| MI15 | 5 | 10 | 215 | 210 | 43 |
| MI16 | 11 | 41 | 150 | 139 | 12 |
| VE11 | 4 | 20 | 5000 | 4996 | 1153 |
| VE12 | 4 | 5 | 166 | 162 | 38 |
| VE13 | 3 | 5 | 154 | 150 | 47 |
| VE14 | 3 | 12 | 5000 | 4997 | 1704 |
| VE15 | 3 | 5 | 1808 | 1805 | 630 |
| VE16 | 3 | 7 | 137 | 133 | 41 |
| DE1 | 39 | 141 | 212 | 174 | 4 |
| DE2 | 23 | 115 | 216 | 194 | 9 |
| DE3 | 16 | 80 | 163 | 147 | 9 |
| DE4 | 15 | 89 | 5000 | 4985 | 324 |
| DE5 | 19 | 97 | 260 | 241 | 13 |
| DE6 | 16 | 83 | 253 | 236 | 14 |
| MA1 | 44 | 78 | 108 | 65 | 1 |
| MA2 | 38 | 129 | 200 | 162 | 4 |
| MA3 | 25 | 54 | 80 | 55 | 2 |
| MA4 | 24 | 77 | 138 | 114 | 5 |
| MA5 | 23 | 45 | 68 | 45 | 2 |
| MA6 | 40 | 153 | 257 | 217 | 5 |

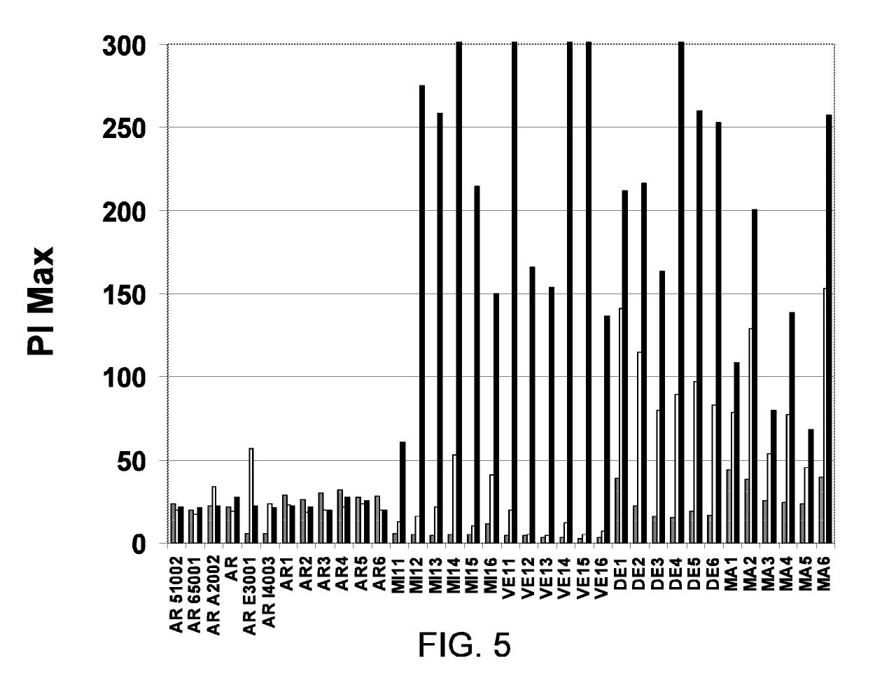

The PIE-max results of Table 5 are graphically displayed in FIG. 5. The Millenniata discs' PIE-max values were largely unchanged by exposure to heat, humidity, and light. The Mitsubishi and Verbatim discs had lower initial PIE-max values, but significantly higher PIE-max values after 48-hour exposure. The Delkin and MAM-A discs had similar initial PIE-max values as the Millenniata discs, but significantly higher PIE-max values after both 24-hour and 48-hour exposure.

TABLE 6
PIE-average values

| Disc | Initial | 24 Hour | 48 Hour | Delta | Delta % |
|---|---|---|---|---|---|
| AR 51002 | 9 | 6 | 6 | 2 | 0 |
| AR 65001 | 7 | 5 | 6 | 1 | 0 |
| AR A2002 | 7 | 5 | 6 | 1 | 0 |
| AR B6002 | 7 | 5 | 7 | 0 | 0 |
| AR E3001 | 1 | 11 | 6 | 5 | 8 |
| AR I4003 | 1 | 6 | 5 | 5 | 9 |
| AR1 | 11 | 7 | 7 | 4 | 0 |
| AR2 | 11 | 7 | 8 | 3 | 0 |
| AR3 | 13 | 7 | 7 | 6 | 0 |
| AR4 | 13 | 7 | 8 | 6 | 0 |
| AR5 | 11 | 9 | 9 | 2 | 0 |
| AR6 | 12 | 7 | 7 | 5 | 0 |
| MI11 | 1 | 2 | 19 | 18 | 29 |
| MI12 | 1 | 5 | 144 | 144 | 285 |
| MI13 | 0 | 4 | 112 | 112 | 260 |
| MI14 | 0 | 11 | 3343 | 3342 | 8622 |
| MI15 | 0 | 2 | 115 | 114 | 255 |
| MI16 | 3 | 16 | 50 | 48 | 18 |
| VE11 | 0 | 4 | 5000 | 5000 | 23926 |
| VE12 | 0 | 1 | 49 | 49 | 347 |
| VE13 | 0 | 1 | 47 | 47 | 595 |
| VE14 | 0 | 3 | 5000 | 5000 | 55067 |
| VE15 | 0 | 0 | 1714 | 1714 | 17878 |
| VE16 | 0 | 1 | 33 | 33 | 199 |
| DE1 | 8 | 62 | 120 | 113 | 15 |
| DE2 | 5 | 54 | 128 | 123 | 23 |
| DE3 | 4 | 34 | 89 | 85 | 23 |
| DE4 | 3 | 45 | 5000 | 4997 | 1630 |
| DE5 | 4 | 50 | 165 | 160 | 36 |
| DE6 | 4 | 41 | 156 | 152 | 39 |
| MA1 | 15 | 34 | 50 | 35 | 2 |
| MA2 | 13 | 59 | 108 | 96 | 8 |
| MA3 | 8 | 22 | 38 | 30 | 4 |
| MA4 | 8 | 37 | 81 | 73 | 9 |
| MA5 | 7 | 19 | 31 | 24 | 4 |
| MA6 | 14 | 84 | 183 | 169 | 12 |

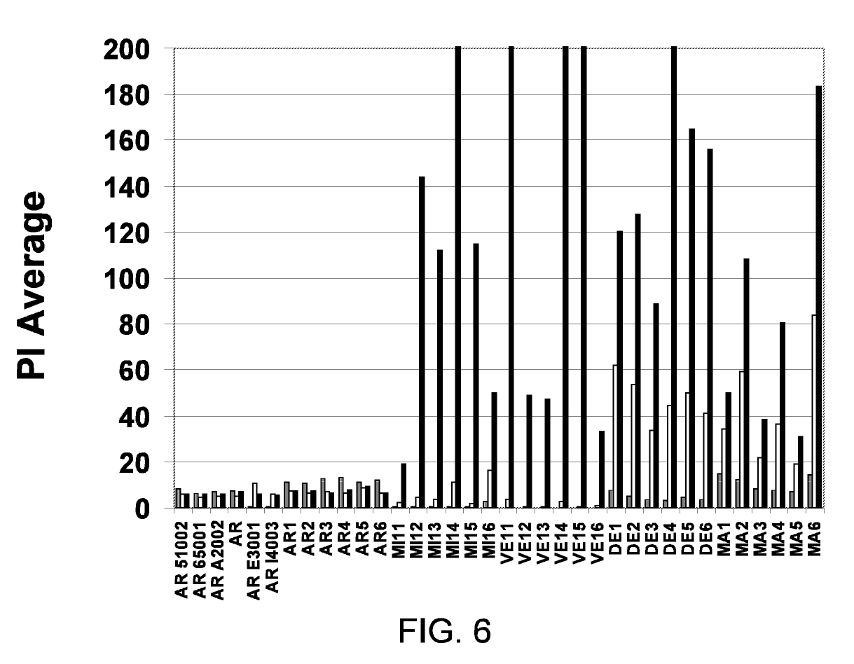

The PIE-average results of Table 6 are graphically displayed in FIG. 6. The Millenniata discs' PIE-average values were largely unchanged or slightly decreased by exposure to heat, humidity, and light. The Mitsubishi and Verbatim discs had lower initial PIE-average values, but significantly higher PIE-average values after 48-hour exposure. The Delkin and MAM-A discs had similar initial PIE-average values as the Millenniata discs, but significantly higher PIE-average values after both 24-hour and 48-hour exposure.

### Example 5

### Evaluation of Combinations of Optical Media and Media Drives

Five manufacturers of optical media DVD discs (Delkin, MAM-A, Mitsubishi, Taiyo Yuden, and Verbatim), and three manufacturers of optical media disc drives (Pioneer, Optiarc, and NEC) were selected for evaluation. Three discs from each manufacturer were used in the test, and their quality values were averaged. The Pioneer DVD drive was model number DVR-116A (Pioneer Corporation; Tokyo, Japan). The Optiarc DVD drive was model number AD 5170A (Sony Optiarc Inc.; Tokyo, Japan). The NEC DVD drive was model number ND-3550A (NEC Corporation; Santa Clara, Calif.).

A 400 MB data file was written to each disc using the drives. The quality of the data file was evaluated using PIE8-maximum obtained from the ShuttlePlex DVD analyzer (Optical Disc Technologies; Irvine, Calif.). A total of fifteen values were obtained (five disc manufacturers times three drive manufacturers, with each disc value being the average of three discs). The following table lists the PIE8-maximum values obtained.

TABLE 7
PIE8-maximum values for media-drive combination

| | Optiarc | NEC | Pioneer |
|---|---|---|---|
| Delkin | 539.8 | 295.4 | 109 |
| MAMA | 1731.8 | 1070.4 | 64.8 |
| Mitsubishi | 22.4 | 20.8 | 40.8 |
| Taiyo-Yuden | 52.8 | 109.8 | 32 |
| Verbatim | 83.4 | 94 | 34.6 |

Values were graphically displayed using common spreadsheet and graphing software on an Apple Macintosh MacBook Pro computer, and are shown in FIG. 7. The optimal combination of optical media and media drive is the one giving the lowest PIE8-maxi mum value. In this case, the optimum was the Mitsubishi disc and the NEC drive, giving a value of 20.8.

### SUMMARY

The above examples demonstrate that it is possible to quickly make quality determinations of media. After tests of only 48 hours of duration it was found that certain media showed significant PIE deterioration, when compared to other media that showed little or no PIE deterioration. This provides an effective comparative measure of data retention of these media, not only when exposed to extreme conditions, but also the expected length of data retention at room temperature, humidity and light conditions.

By making an initial PIE evaluation and comparing that to the PIE after the simultaneous exposure to elevated heat, humidity, and light, allows for prediction of the expected data-retention time under ordinary conditions. This leads to the conclusion that Millenniata media would be expected to retain data significantly longer than the other media in the comparison. This determination was obtained after relatively short 48-hour comparative tests. This contrasts with conventional testing, which would have required several weeks to obtain data-retention results that show this differentiation between higher and lower quality media.

All of the compositions and/or methods and/or processes and/or apparatus disclosed and claimed herein can be made and executed without undue experimentation in light of the present disclosure. While the compositions and methods have been described, it will be apparent to those of skill in the art that variations may be applied to the compositions and/or methods and/or apparatus and/or processes and in the steps or in the sequence of steps of the methods described herein without departing from the concept and scope of the invention. More specifically, it will be apparent that certain agents which are both chemically and physically related may be substituted for the agents described herein while the same or similar results would be achieved. All such similar substitutes and modifications apparent to those skilled in the art are deemed to be within the scope and concept of the invention.

What is claimed is:

1. A method for evaluating the reliability of optical media, the method comprising:
evaluating the initial quality of the optical media;
simultaneously exposing the optical media for a period of time to elevated heat, elevated humidity, and light; and
evaluating the post-exposure quality of the optical media.

2. The method of claim 1, wherein the optical media are CD discs, DVD discs, or blu-ray discs.

3. The method of claim 1, wherein evaluating the initial quality and the post-exposure quality comprises measuring block error rate (BLER), parity inner error (PIE), parity inner error 8 max (PIE8 max; maximum of the sum of Parity Inner Errors in 8 consecutive ECC blocks), parity inner error 8 average (PIE8 average; average of the sum of Parity Inner Errors in 8 consecutive ECC blocks), parity inner error 8 events (PIE8 events), PIF (parity inner failures), PIF bytes, POF (parity outer failures), jitter, or combinations thereof.

4. The method of claim 1, wherein the elevated heat is about 60° C. to about 120° C., the elevated humidity is about 75% to about 100%, and the light has an intensity of about 0.1 mWatts/cm² to about 1,000 mWatts/cm².

5. The method of claim 1, wherein the elevated heat is about 80° C., the elevated humidity is about 85%, and the light has an intensity of about 40 mWatts/cm² to about 60 mWatts/cm².

6. The method of claim 1, wherein the light comprises UVA light, UVB light, or both UVA and UVB light.

7. The method of claim 1, wherein the period of time is between about 24 hours and 120 hours.

8. The method of claim 1, comprising measuring the post-exposure quality at multiple periods of time.

9. The method of claim 1, comprising continuously measuring the post-exposure quality during the exposing step.

10. The method of claim 1, further comprising comparing the initial quality and the post-exposure quality.

11. A method for evaluating combinations of optical media and media drives, the method comprising:
providing M number of optical media;
providing N number of media drives;
writing data to the optical media using each combination of optical media and media drives;
measuring the post-writing quality values of each of the optical media, for a total of M times N measured quality values; and comparing the measured quality values; wherein
M is an integer of one or more;
N is an integer of one or more; and
at least one of M and N is two or more.

12. The method of claim 11, wherein measuring the post-writing quality comprises measuring block error rate (BLER), parity inner error (PIE), parity inner error 8 max (PIE8 max; maximum of the sum of Parity Inner Errors in 8 consecutive ECC blocks), parity inner error 8 average (PIE8 average; average of the sum of Parity Inner Errors in 8 consecutive ECC blocks), parity inner error 8 events (PIE8 events), PIF (parity inner failures), PIF bytes, POF (parity outer failures), jitter, or combinations thereof.

13. The method of claim 11, wherein M is two or more, and N is two or more.

14. A system for evaluating the reliability of optical media, the system comprising:
at least one article of optical media;
an analyzer device that evaluates the initial quality of the optical media and the post-exposure quality of the optical media; and
an environmental chamber that simultaneously exposes the optical media to elevated heat, elevated humidity, and light.

15. The system of claim 14, further comprising a graphical display device to compare the initial quality of the optical media and the post-exposure quality of the optical media.

16. The system of claim 14 wherein the environmental chamber comprises:
a heat source;
a humidity source;
a light source;
a controller that controls heat, humidity, and light in the chamber; and
a holder that holds multiple optical media; wherein the chamber is configured to simultaneously expose the multiple optical media to elevated heat, elevated humidity, and light.

17. The system of claim 16, wherein the media is positioned within the chamber at fixed locations.

18. The system of claim 16, wherein the media is movably positioned within the chamber.

19. The system of claim 16, wherein the holder holds the multiple optical media at about equal distances from the light source.

20. The system of claim 16, wherein the holder comprises a carousel or conveyer.
